(19) United States
(12) Patent Application Publication
(10) Pub. No.: US 2026/0358131 A1
(43) Pub. Date: Nov. 12, 2026

(54) SYSTEM FOR CALCULATING EVACUATION ROUTES BASED ON CBR CONTAMINATION SPREAD PREDICTION AND CONTROLLING METHOD FOR THE SAME

(71) Applicant: AGENCY FOR DEFENSE DEVELOPMENT, Daejeon (KR)

(72) Inventors: Hyunwoo NAM, Daejeon (KR); Donghee KANG, Daejeon (KR)

(21) Appl. No.: 19/382,598

(22) Filed: Nov. 7, 2025

(30) Foreign Application Priority Data
May 7, 2025 (KR) 10-2025-0058931

(51) Int. Cl. G01C 21/34

(52) U.S. Cl. CPC G01C 21/3461; G01C 21/3446; G01C 21/3492

(57) ABSTRACT

There are provided an evacuation route calculation system based on CBR contamination spread prediction and a control method therefor. The system and method enable automatic calculation of an evacuation route from a starting point near an accident site to a safe area, based on time-based contamination spread prediction data acquired from a CBR contamination spread prediction tool within a user-defined area when a CBR situation occurs. Therefore, a faster and more reliable CBR evacuation route can be calculated to maximize the safety of evacuees. By applying spatial information such as time-based contamination spread data, roads, and traffic volume to an optimal route calculation algorithm when a CBR contamination occurs, the system and method can calculate and provide guidance on an optimal evacuation route to quickly evacuate people from the contaminated area to a safe zone, thereby minimizing human casualties.

### CROSS-REFERENCE TO RELATED APPLICATION

This application claims priority to Korean Patent Application No. 10-2025-0058931 filed on May 7, 2025, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to a system for calculating evacuation routes based on CBR (Chemical, Biological, and Radiological) contamination spread prediction and a controlling method for the same. More particularly, the present disclosure relates to a system and method that automatically calculate an escape route from a starting point near the incident site to a safe zone based on time-series contamination spread prediction data obtained from a CBR contamination spread prediction tool within a user-defined area when a CBR situation occurs, thereby enabling faster and more reliable calculation of evacuation routes under CBR contamination scenarios.

### Description of the Related Art

In general, various types of gases can be used in industrial sites or storage facilities for diverse purposes. In the process of storing and using such gases, it is extremely important to detect and suppress at an early stage any leakage of gases that are fatal to humans or explosive in order to prevent human casualties and the escalation of large-scale accidents. Recently, with ongoing industrialization, various hazardous substances are generated not only in industrial complexes densely populated with large cities and factories but also in rural areas, resulting in increased environmental pollution, which has emerged as a significant social issue.

In addition to such environmental pollution, accidents involving human casualties frequently occur due to the leakage of hazardous substances in factories that handle harmful chemicals or the leakage of toxic gases generated during processes. Moreover, due to recent changes in rapidly shifting international circumstances, the threat of terrorist incidents using toxic chemical warfare agents (CWA), employed as weapons of terrorism such as chemical weapons, is also increasing.

Accordingly, in order to prevent loss of life and property caused by such unexpected accidents or acts of terrorism, it is essential to constantly monitor the presence and concentration of hazardous substances in the air, promptly detect the occurrence of hazardous gases, and immediately evacuate people as part of an early response. Furthermore, chemical, biological, and radiological (CBR) terrorism, which has been rapidly increasing in recent years, is even more dangerous and fatal, making it extremely necessary to track it in advance.

In particular, chemical warfare agents (CWA) such as nerve agents and blister agents, which are used for terrorist purposes, and toxic industrial chemicals (TIC) from chemical plants are colorless and odorless. In the event of a leakage accident, they can cause significant casualties in a short period of time. Therefore, in order to prevent such damage in advance and monitor the spread of contamination, it is necessary to install and operate sensors in protected areas.

Referring now to FIG. 1, an example of a conventional CBR contamination tracking device comprises: a sensor unit 70 configured to detect leakage of various hazardous gases; a network interface 71 connected to the sensor unit 70 and configured to transmit a detection signal detected by the sensor unit 70; a processor 72 connected to the network interface 71 and configured to control the entire process of hazardous gas leakage tracking operations; and a memory 73 configured to store one or more instructions under the functional control of the processor 72.

Meanwhile, in operation of the conventional CBR contamination tracking device described above, at first, the processor 72 is connected to the sensor unit 70 via the network interface 71 and executes one or more instructions, such as tracking whether hazardous gas leakage has occurred.

Here, the processor 72 acquires images of a monitored space from multiple cameras 74a-74n provided in the sensor unit 70. The processor 72 then checks whether a target object related to the hazardous gas is identified from the images captured by the cameras 74a-74n of the sensor unit 70.

When the target object is identified, the processor 72 separates a target object region related to the target object from each of the images and, based on state information relating to at least one of the shape, flow, or movement of the target object appearing in the separated target object region, identifies a leakage source from which the target object related to the hazardous gas originated.

Furthermore, the processor 72 determines whether the identified target object satisfies a warning condition, which is set differently according to at least one of the state information or the leakage source, and, based on the determination, decides whether hazardous gas leakage has occurred, stores the result in the memory 73, and generates a warning signal.

More specifically, the processor 72 determines that the target object satisfies the warning condition when the leakage amount of the target object identified at the leakage source exceeds a first critical leakage amount. Additionally, when the leakage amount of the target object identified at the leakage source is equal to or less than the first critical leakage amount but exceeds a second critical leakage amount, and the volume of the monitored space corresponding to the leakage source is identified as being less than a first critical volume, the processor 72 also determines that the target object satisfies the warning condition and uses this information to track the hazardous gas leakage.

However, the conventional CBR contamination tracking device as described above suffers from several problems. Sensor devices capable of detecting CBR contamination, including hazardous gases, are extremely expensive, and the cost of operating them is also very high.

As a result, there are limitations to installing them over a wide area, and they can only be installed in limited locations within a specific area. Consequently, significant difficulties arise in performing precise tracking of CBR contamination sources.

In addition, due to the complexity of interpreting contamination spread prediction data, wide contamination area, and limitations in acquiring databases such as road data within a region, there are inherent limitations in system development and practical applicability.

As a result, it is very difficult to determine how much time has elapsed since the incident occurred or to identify where the initial occurrence point locates.

Furthermore, because the tracking process relies solely on measurements from sensor devices installed only in such limited areas, the process of tracking and predicting CBR contamination sources is not sufficiently reliable and poses significant limitations in appropriately responding to hazardous situations.

### RELATED PATENT DOCUMENT

Korean Registered Patent Publication No. 10-2712838

### SUMMARY OF THE DISCLOSURE

The purpose of the present disclosure, which aims to solve the aforementioned conventional problems, is to provide a system for calculating evacuation routes based on CBR contamination spread prediction and a controlling method for the same, which can automatically calculate an escape route from a starting point near the incident site to a safe zone based on time-series contamination spread prediction data obtained from a CBR contamination spread prediction tool within a user-defined area when a CBR situation occurs, thereby enabling faster and more reliable calculation of CBR evacuation routes.

In addition, another purpose of the present disclosure is to provide a system for calculating evacuation routes based on CBR contamination spread prediction and a controlling method for the same, which can apply time-series contamination spread data, as well as spatial information such as roads and traffic volume, to an optimal route calculation algorithm in the event of a CBR contamination incident, thereby calculating and guiding an optimal evacuation route to enable refugees to quickly evacuate from CBR contamination to a safe area.

In order to achieve the above purposes, an aspect of the present disclosure provides an evacuation route calculation system based on CBR contamination spread prediction, comprising:
an input information acquisition unit configured to acquire user input information including at least one selected from the group consisting of modeling target spatial information, CBR contamination source information, and environment setting information;
a contamination spread prediction modeling data acquisition unit configured to calculate contamination spread prediction data in a space included in the user input information acquired by the input information acquisition unit by utilizing a contamination spread prediction tool;
an evacuation route calculation modeling unit configured to calculate an optimal evacuation route based on contamination information for each time period on roads and traffic volume, from the user input information acquired by the input information acquisition unit; and
an operation control module configured to comprehensively control the operation and functions of the input information acquisition unit, the contamination spread prediction modeling data acquisition unit, and the evacuation route calculation modeling unit, and to generate output information including an image or a video of the optimal evacuation route calculated based on a predicted contamination concentration.

In some exemplary embodiments, the input information acquisition unit may further comprise:
an input unit configured to input various conditions and environment setting information required for modeling to calculate an evacuation route; and
a spatial information acquisition unit configured to acquire modeling target spatial information for calculating the evacuation route.

In some exemplary embodiments, the input unit may be configured to input spatial information and environment setting information for calculating an optimal evacuation route in the event of a CBR incident, and to input environment setting information including various conditions and parameters for modeling, and
the spatial information acquisition unit may be configured to allow a user to select a target space to be predicted from a pre-stored space including road and traffic volume information of the target space.

In some exemplary embodiments, model input information of the input information acquisition unit may further comprise spatial information including roads and traffic volume according to a function control signal of the operation control module.

In some exemplary embodiments, the contamination spread prediction modeling data acquisition unit may further comprise a function of acquiring, online or offline, the contamination spread prediction data in the space for each time period; and
the contamination spread prediction data may be calculated by utilizing a contamination spread prediction modeling tool based on user input information acquired by the input information acquisition unit.

In some exemplary embodiments, the evacuation route calculation modeling unit may further comprise a function of generating an optimal evacuation route in time sequence, based on the user input information acquired by the input information acquisition unit according to a function control signal of the operation control module and the contamination spread prediction data between a start point and an end point; and
the contamination spread prediction data may be received as input information calculated by the contamination spread prediction modeling data acquisition unit.

In some exemplary embodiments, a shortest path finding algorithm of the evacuation route calculation modeling unit may comprise:
a process of calculating a cost by referring to road length, traffic volume, and expected contamination concentration during passage in a sequential movement process from a user-designated start point to a destination; and
a process of finding a route having a minimum cost by summing a cost calculated at a current point and an expected cost for reaching the destination.

In some exemplary embodiments, the operation control module may further comprise a function of calculating an optimal evacuation route by utilizing a shortest path finding algorithm including the following Equations 1 and 2:

f(n)=g(n)+a·h(n) [Equation 1]
where f(n) represents a total cost (unit: seconds) calculated by summing an accumulated movement cost g(n) from a starting point to a current node (n step) and an expected risk cost h(n) expected on a remaining path between the current node (n step) and a destination;
g(n) represents an accumulated movement cost (unit: seconds) calculated by accumulating residence times of road links actually passed from the starting point to the current node (n step);
h(n) represents an expected risk cost (unit: seconds) calculated by accumulating products of residence time and contamination prediction concentration for each link on a remaining path from the current node (n step) to the destination; and
α denotes a risk reflection coefficient (range: 1.0-10.0) for adjusting the degree of reflection of the expected risk cost h(n).

$$h ( n ) = {{\sum }_{min}}_{path} ( residence time ( T ) \times contamination prediction concentration ( C ) ) \qquad [ Equation 2 ]$$

$$T = \frac{L ( i , j )}{v}$$

where h(n) represents an expected risk cost (unit: seconds) obtained by converting a risk exposure amount into a time cost by multiplying a contamination prediction concentration C and a residence time T for each road link (i, j) on a remaining path from the current node (n step) to the destination, and then summing time costs for all road links on the remaining path;
L(i, j) denotes a road link length (unit: meters);
v denotes a travel speed required to pass through the road link (i, j) (unit: m/sec);
T denotes a residence time required to pass through the road link (i, j) (unit: seconds); and
C denotes a contamination prediction concentration (unit: mg/m³) indicating an estimated degree of contamination exposure of a road at a given time during travel.

In some exemplary embodiments, the spatial information acquisition unit may be configured to store spatial information acquired by the spatial information acquisition unit in an internal memory unit through a preprocessing process for performing an evacuation route calculation modeling function.

In some exemplary embodiments, the contamination spread prediction modeling data acquisition unit may be configured to output data predicting a time-based contamination concentration (unit: mg/m³) on a ground surface; and
the data may be obtained as a result of a simulation performed for an area acquired by the spatial information acquisition unit by utilizing a contamination spread prediction modeling tool according to a function control signal of the operation control module.

In some exemplary embodiments, the evacuation route calculation modeling unit may further comprise a function of calculating an optimal evacuation route according to a function control signal of the operation control module, based on a start point, a destination, and CBR incident information acquired by a user through a user input unit, an area acquired by the spatial information acquisition unit, and contamination spread prediction information acquired by the contamination spread prediction modeling data acquisition unit.

Furthermore, another aspect of the present disclosure provides a control method for an evacuation route calculation system based on CBR contamination spread prediction, comprising:
a first step of inputting, by an input information acquisition unit, according to a function control signal of an operation control module, model input information including at least one selected from the group consisting of modeling target spatial information and environment setting information;
a second step of receiving, after the first step, by the operation control module, data acquired by utilizing a contamination spread prediction tool within an area;
a third step of calculating, after the second step, by an evacuation route calculation modeling unit, according to a function control signal of the operation control module, an optimal evacuation route based on spatial information including roads, an evacuation start point and a destination, and contamination spread data; and
a fourth step of generating, after the third step, by the operation control module, output information including an image or a video of an evacuation route result created based on a contamination concentration calculated by the evacuation route calculation modeling unit.

In some exemplary embodiments, the first step may further comprise:
an information input step of acquiring system input information according to a function control signal of the operation control module, wherein an input unit inputs environment setting information including an evacuation start point and a destination to which evacuation is intended; and
a spatial information input step of inputting, by a spatial information acquisition unit, spatial information including roads and traffic volume as modeling target information.

In some exemplary embodiments, the model input information of the first step may further comprise at least one selected from the group consisting of user input information and analysis control setting information.

In some exemplary embodiments, the second step may comprise receiving, according to a function control signal of the operation control module, contamination spread prediction data including time-based contamination concentration data calculated by a CBR contamination prediction tool, and
the second step may further comprise an offline method of reading pre-stored files and an online method of receiving contamination spread prediction data through a real-time network connection.

In some exemplary embodiments, the third step may further comprise an optimal evacuation route calculation step of calculating, by utilizing an evacuation route calculation modeling technique, an optimal evacuation route from a start point to a destination within a designated area based on roads, traffic volume, and contamination spread prediction data; and
the optimal evacuation route calculation step may comprise analyzing time-based contamination spread concentration, road, and traffic volume information calculated by a contamination spread prediction tool, and calculating risk levels from the start point to the destination defined by a user by utilizing a GPU parallel acceleration computation technique to calculate the optimal evacuation route.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, an evacuation route from a starting point near an accident site to a safe area can be automatically calculated based on time-based contamination spread prediction data acquired from a CBR contamination spread prediction tool within a user-defined area when a CBR situation occurs, thereby providing the effect of calculating a faster and more reliable CBR evacuation route and consequently maximizing the safety of evacuees.

Moreover, the present disclosure also provides the effect of minimizing human casualties by applying spatial information such as time-based contamination spread data, roads, and traffic volume to an optimal route calculation algorithm to calculate and guide an optimal evacuation route when a CBR contamination occurs, thereby enabling rapid evacuation of evacuees from contaminated areas to safe zones.

### BRIEF DESCRIPTION OF THE DRAWINGS

FIG. 1 is a diagram illustrating an example of a conventional CBR contamination tracking device.

FIG. 2 is an explanatory diagram illustrating an evacuation route calculation system based on CBR contamination spread prediction according to an exemplary embodiment of the present disclosure.

FIG. 3 is a flowchart illustrating a control method for an evacuation route calculation system based on CBR contamination spread prediction according to an exemplary embodiment of the present disclosure.

FIG. 4 is an explanatory diagram illustrating an example of results calculated in the control method for an evacuation route calculation system based on CBR contamination spread prediction according to an exemplary embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Moreover, one or more “unit” and/or “module” described in this specification can be implemented via a non-transitory memory (not shown) and a processor (not shown). The memory is configured to store data concerning algorithms designed to control the operation of system components according to exemplary embodiments of the present disclosure, or software instructions that implement these algorithms. The processor is configured to perform the operations described below using the data stored in the memory. Here, the memory and the processor may be implemented as separate chips. Alternatively, the memory and the processor may be implemented as a single integrated chip. The processor may take the form of one or more processors.

Furthermore, in the specification of the present disclosure, terms such as “unit,” “device,” “module,” and “apparatus,” if used, refer to a unit capable of processing one or more functions or operations and should be understood to be implementable in hardware, software, or a combination of hardware and software.

As will be understood by those skilled in the art, the realization of all or some of the steps of the above exemplary embodiments may be accomplished through hardware, or may be accomplished by directing the relevant hardware through a computer program. The computer program may include instructions for executing some or all of the steps of the method, the computer program may be stored on a readable storage medium, and the storage medium may be any form of storage medium.

Hereinafter, exemplary embodiments of the present disclosure will be described in detail with reference to related drawings.

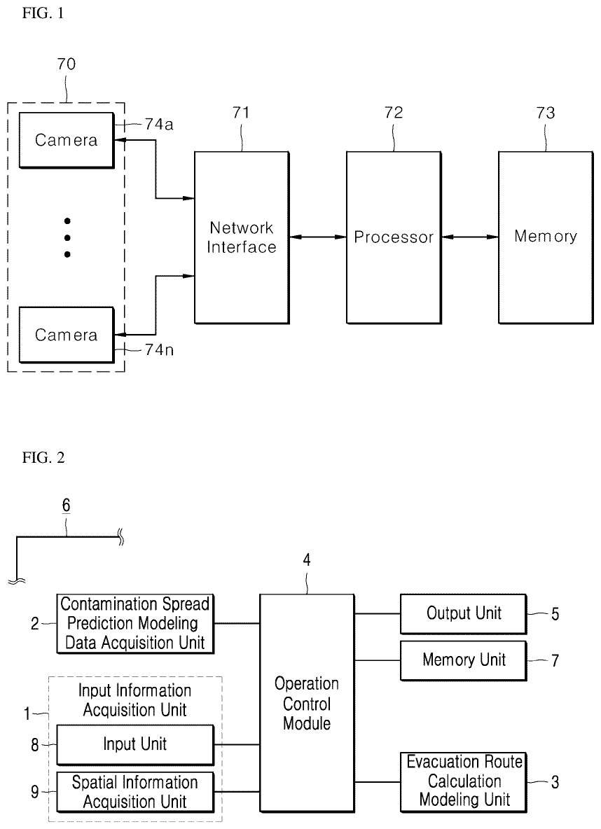

FIG. 2 is an explanatory diagram illustrating an evacuation route calculation system based on CBR contamination spread prediction according to an exemplary embodiment of the present disclosure.

Referring to FIG. 2, an evacuation route calculation system based on CBR contamination spread prediction according to an exemplary embodiment of the present disclosure comprises: an input information acquisition unit 1 configured to acquire user input information including at least one selected from the group consisting of modeling target spatial information, CBR contamination source information, and environment setting information; a contamination spread prediction modeling data acquisition unit 2 configured to calculate contamination spread prediction data in a space included in the user input information acquired by the input information acquisition unit 1 by utilizing a contamination spread prediction tool (Tool); an evacuation route calculation modeling unit 3 configured to calculate an optimal evacuation route based on contamination information for each time period on roads and traffic volume from the user input information acquired by the input information acquisition unit 1; and an operation control module 4 configured to comprehensively control the operation and functions of the input information acquisition unit 1, the contamination spread prediction modeling data acquisition unit 2, and the evacuation route calculation modeling unit 3, and to generate output information including an image or a video of the optimal evacuation route calculated based on a predicted contamination concentration.

In addition, the operation control module 4 may further include an output unit 5 for displaying the output information generated by the operation control module 4 to the outside, and a memory unit 7 for storing data processed by the evacuation route calculation system 6 based on CBR contamination spread prediction according to an exemplary embodiment of the present disclosure, including the operation control module 4.

Furthermore, model input information of the input information acquisition unit 1 further includes spatial information such as roads and traffic volume according to a function control signal of the operation control module 4. The input information acquisition unit 1 further comprises an input unit 8 configured to input various conditions and environment setting information required for modeling to calculate an evacuation route, and a spatial information acquisition unit 9 configured to acquire modeling target spatial information for calculating the evacuation route. That is, the input unit 8 may be configured to input spatial information and environment setting information for calculating an optimal evacuation route in the event of a CBR incident, and to allow a user to input environment setting information including various conditions and parameters for modeling. Furthermore, the spatial information acquisition unit 9 may be configured to acquire modeling target spatial information for calculating an evacuation route, and may be configured to allow a user to select a target space from a pre-stored space including information such as road and traffic volume information of the target space to be predicted.

That is, the evacuation route calculation system 6 based on CBR contamination spread prediction according to an exemplary embodiment of the present disclosure provides a system capable of calculating an optimal route between a user-specified starting point and evacuation area based on time-based contamination prediction information over spatial information defined by a user.

In addition, the contamination spread prediction modeling data acquisition unit 2 further comprises a function of acquiring, online or offline, contamination spread prediction data in the space for each time period calculated by utilizing, for example, contamination spread prediction modeling tools such as HPAC and NBC_RAMS based on user input information acquired by the input information acquisition unit 1 according to a function control signal of the operation control module 4.

In addition, the evacuation route calculation modeling unit 3 may further comprise a function of generating an optimal evacuation route in time sequence based on user input information acquired by the input information acquisition unit 1 according to a function control signal of the operation control module 4 and contamination spread prediction data between a start point and an end point calculated by the contamination spread prediction modeling data acquisition unit 2.

The technique for calculating an optimal evacuation route generated by the evacuation route calculation modeling unit 3 is a shortest path finding software algorithm according to a function control signal of the operation control module 4. More specifically, the shortest path finding algorithm includes a process of calculating a cost by referring to road length, traffic volume, and expected contamination concentration during passage in a sequential movement process from a user-designated start point to a destination, and a process of finding a route having a minimum cost by summing a cost calculated at a current point and an expected cost for reaching the destination.

In an exemplary embodiment of the present disclosure, contamination spread prediction data of CBR substances sequentially predicted over time are converted into information mapped on a map to estimate the degree of road contamination for each time period and to include it in cost calculation. The shortest path finding algorithm according to an exemplary embodiment of the present disclosure can be more effectively utilized for the purpose of evacuation route setting in a CBR situation, as compared with a conventional simple shortest path-based route finding algorithm, by calculating an optimal evacuation route reflecting the degree of road contamination in the event of a CBR contamination incident.

Here, the following Equation 1 is calculated by the shortest path finding algorithm according to an exemplary embodiment of the present disclosure, that is, an algorithm for performing optimal evacuation route finding based on contamination spread prediction data.

f(n)=g(n)+a·h(n) [Equation 1]
where f(n) represents a total cost (unit: seconds) calculated by summing an accumulated movement cost g(n) from a starting point to a current node (n step) and an expected risk cost h(n) expected on a remaining path between the current node (n step) and a destination;
g(n) represents an accumulated movement cost (unit: seconds) calculated by accumulating residence times of road links actually passed from the starting point to the current node (n step);
h(n) represents an expected risk cost (unit: seconds) calculated by accumulating products of residence time and contamination prediction concentration for each link on a remaining path from the current node (n step) to the destination; and
α denotes a risk reflection coefficient (range: 1.0-10.0) for adjusting the degree of reflection of the expected risk cost h(n).

According to an exemplary embodiment of the present disclosure, g(n) may be calculated as a total residence time of road links included in an accumulated route from a departure location to a current point, and the residence time of each link may be calculated based on the length of the road and a real-time travel speed at each time period, expressed in seconds (sec).

In addition, a may be adjusted to control the degree of reflection of the expected risk cost h(n) according to a protection level, CBR response stage, or operation policy.

Furthermore, while conventional algorithms use a Euclidean distance (straight-line distance) calculation for the expected risk cost h(n), the shortest path finding algorithm according to an exemplary embodiment of the present disclosure further includes the speed reflecting the distance and traffic volume for each road, as well as expected contamination concentration information.

In particular, the shortest path finding algorithm according to an exemplary embodiment of the present disclosure performs optimal evacuation route finding by updating contamination prediction information in spatial and temporal units, considering contamination spread that changes in time series according to the movement point, and introduces a time-weighted contamination exposure risk h(n) into a heuristic-based A* algorithm. The algorithm quantifies an accumulated time cost g(n) representing the actual passage time from the starting point to the current point, converts contamination exposure into a time cost by multiplying residence time (T) by contamination prediction concentration (C), and introduces a user-adjustable or policy-based risk reflection coefficient α to control sensitivity to contamination conditions.

The risk reflection coefficient α according to an exemplary embodiment of the present disclosure may be adjusted according to user settings or operational criteria for each situation. For example, when the protection level is relatively low, the a value may be set higher to increase sensitivity to the risk cost, whereas when a certain level of protective equipment or safety measures is secured, the a value may be set lower.

For instance, when a is set to 1.0, it reflects a general level of risk aversion, and when a is set to 5.0 or higher, a stronger tendency to avoid risk areas is reflected, prioritizing safer road-centered routes. Adjustment of a may be flexibly applied according to the CBR response stage, the level of availability of personal protective equipment according to a CBR situation, and characteristics of evacuees (for example, elderly persons or the general public).

In other words, by introducing an expected contamination exposure risk into the heuristic-based A* algorithm, the shortest path finding algorithm according to an exemplary embodiment of the present disclosure enables avoidance of contaminated areas and increases the cost of high-risk paths caused by contamination, thereby excluding them from route exploration.

In addition, by applying the risk reflection coefficient α to risk cost evaluation, the evacuation route finding result can be flexibly controlled according to a level of risk perception or response strategy during a CBR incident, thereby providing an effect of calculating an evacuation route suitable for a CBR situation, which cannot be achieved by conventional distance-based or fixed-cost-based search methods.

$$h ( n ) = {{\sum }_{min}}_{path} ( residence time ( T ) \times contamination prediction concentration ( C ) ) \qquad [ Equation 2 ]$$

$$T = \frac{L ( i , j )}{v}$$

where h(n) represents an expected risk cost (unit: seconds) obtained by converting a risk exposure amount into a time cost by multiplying a contamination prediction concentration C and a residence time T for each road link (i, j) on a remaining path from the current node (n step) to the destination, and then summing time costs for all road links on the remaining path;
L(i, j) denotes a road link length (unit: meters);
v denotes a travel speed required to pass through the road link (i, j) (unit: m/sec);
T denotes a residence time required to pass through the road link (i, j) (unit: seconds); and
C denotes a contamination prediction concentration (unit: mg/m³) indicating an estimated degree of contamination exposure of a road at a given time during travel.

Here, the travel speed may be input by a user based on traffic data representing the average vehicle speed, or may be linked with statistical data obtained from public data portals.

The h(n) according to an exemplary embodiment of the present disclosure is calculated as an approximate value of an expected contamination exposure amount for each remaining route from the current point to the destination, and since the contamination exposure amount is defined as a product of residence time and contamination prediction concentration at each link, road sections with high exposure concentration or long residence time have increased risk costs, thus being deprioritized in route exploration.

In addition, when calculating h(n) according to an exemplary embodiment of the present disclosure, contamination prediction concentration is calculated by spatially intersecting the time-based contamination isoconcentration (contour) distribution obtained by the contamination spread prediction modeling data acquisition unit 2 and the positional information of each road link. When a road section predicted to have contamination intersects with multiple isoconcentration contour lines, the contamination exposure concentration at that time may be determined based on the highest concentration.

The contamination prediction concentration (C) denotes a value estimating the degree of contamination exposure of a road at a given time during travel, according to a function control signal of the operation control module 4, and is calculated by the evacuation route calculation modeling unit 3.

More specifically, the operation control module 4 designates a specified road with contamination concentration information of a contour area generated from contamination spread prediction data when the road is included in the contour area, and when the road overlaps with two or more contour areas, the highest contamination concentration value is assigned to the road.

At this time, the evacuation route calculation modeling unit 3 may calculate, based on the contamination spread prediction data, the predicted contamination concentration of each road more quickly by utilizing a GPU parallel acceleration computation technique according to a function control signal of the operation control module 4, based on Equations 1 and 2 as above.

Here, the spatial information acquisition unit 9 may acquire road (link) information defined by a user according to a function control signal of the operation control module 4, and the acquired information may be offline data obtained from statistical sites such as public data portals or online data obtained through linkage.

In addition, the spatial information acquired by the spatial information acquisition unit 9 as described above may be stored in the internal memory unit 7 through a preprocessing process in order to perform an evacuation route calculation modeling function.

In addition, the contamination spread prediction modeling data acquisition unit 2 outputs data predicting time-based spread contamination concentration (mg/m³) on the ground surface as a result of a simulation performed for the region acquired by the spatial information acquisition unit 9 by utilizing a contamination spread prediction modeling tool according to a function control signal of the operation control module 4.

In addition, the evacuation route calculation modeling unit 3 may include a function of calculating an optimal evacuation route based on the start point, destination, and CBR incident information acquired by the user through the user input unit 8, the region acquired by the spatial information acquisition unit 9, and the contamination spread prediction information acquired by the contamination spread prediction modeling data acquisition unit 2, according to a function control signal of the operation control module 4.

Meanwhile, the memory unit 7 may store various data and programs required for the operation of the evacuation route calculation system 6 based on CBR contamination spread prediction according to an exemplary embodiment of the present disclosure.

The memory unit 7 may also store spatial information for the evacuation route calculation based on CBR contamination spread prediction, a CBR contamination substance library, and various environment setting information.

In addition, the input unit 8 is configured to receive, from a user, information such as a start point and a destination for which an evacuation route is to be calculated, contamination substance information, time-based contamination spread prediction modeling data, external environment information (road and traffic volume information), analysis settings, and predefined information, and may further include a mechanical input means and a touch-type input means.

Meanwhile, environmental information such as roads or road traffic volume information for which the evacuation route is to be calculated may be information stored in the memory unit 7. In this case, according to user input through the input unit 8, at least one area may be selected, and various traffic information related to the selected area may also be selected.

In addition, the output unit 5 may output various data of the evacuation route calculation system 100 based on CBR contamination spread prediction according to an exemplary embodiment of the present disclosure, under a function control signal of the operation control module 4.

For example, the output unit 5 may output the evacuation route calculation results as time-based visualized images so that a user can visually track and identify the evacuation route.

To this end, the output unit 5 may include at least one display capable of displaying image information. The display may be implemented as a Cathode Ray Tube (CRT), Plasma Display Panel (PDP), Liquid Crystal Display (LCD), Light Emitting Diode (LED), or Organic Light Emitting Diode (OLED), but is not limited thereto.

Meanwhile, the operation control module 4 controls the overall operation of the evacuation route calculation system 100 based on CBR contamination spread prediction according to an exemplary embodiment of the present disclosure. For example, the operation control module 4 may control the operations and operation order of each connected component, and may cause each connected component to be controlled based on information input through the input unit 8.

At this time, the operation control module 4 may receive, through the input unit 8, at least one piece of pre-stored CBR contamination spread prediction data selected by a user from a list for evacuation route calculation based on CBR contamination spread prediction.

Hereinafter, a control method according to an exemplary embodiment of the present disclosure configured as described above will be explained.

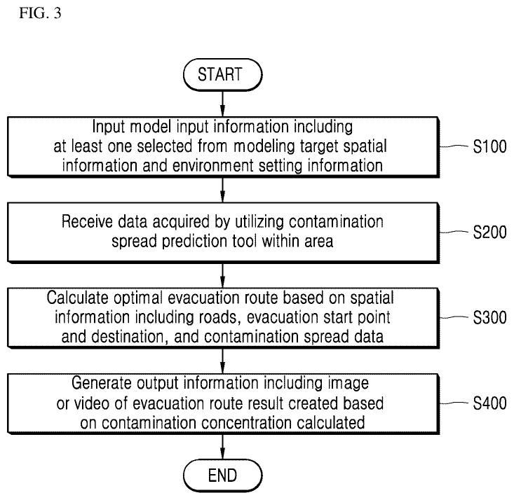

FIG. 3 is a flowchart illustrating a control method of an evacuation route calculation system based on CBR contamination spread prediction according to an exemplary embodiment of the present disclosure.

Referring to FIG. 3, the control method according to an exemplary embodiment of the present disclosure comprises a first step (S100) in which an input information acquisition unit inputs model input information including at least one of modeling target spatial information and environment setting information according to a function control signal of an operation control module; a second step (S200) in which, after the first step (S100), the operation control module receives data obtained by utilizing a contamination spread prediction tool within a designated area; a third step (S300) in which, after the second step (S200), an evacuation route calculation modeling unit calculates an optimal evacuation route from the acquired spatial information such as roads, an evacuation start point, a destination, and contamination spread data according to a function control signal of the operation control module; and a fourth step (S400) in which, after the third step (S300), the operation control module generates evacuation route results, created based on the contamination concentration calculated by the evacuation route calculation modeling unit, as output information including an image or video.

In addition, the fourth step (S400) may further comprise a fifth step (S500) in which the operation control module displays and outputs the generated output information through an output unit.

Here, the first step (S100) may comprise a step of acquiring system input information according to a function control signal of the operation control module, including an information input step in which an input unit inputs environment setting information such as an evacuation start point and destination desired for evacuation, and a spatial information input step in which a spatial information acquisition unit inputs spatial information such as modeling target roads and traffic volume.

The model input information of the first step (S100) may further comprise at least one selected from the group consisting of user input information and analysis control setting information.

In addition, the second step (S200) is a step of receiving, according to a function control signal of the operation control module, time-based contamination spread prediction data (including concentration and other data) calculated by a CBR contamination prediction tool. This may be configured as an offline method of reading pre-stored files or an online method of receiving contamination spread prediction data through a real-time network connection.

The third step (S300) is a step of calculating an optimal evacuation route from a start point to a destination based on roads, traffic volume, and contamination spread prediction data within a currently designated area by utilizing an evacuation route calculation modeling technique, and may further comprise an optimal evacuation route calculation step of analyzing time-based contamination spread concentration, road, and traffic volume information calculated by a contamination spread prediction tool according to an exemplary embodiment of the present disclosure, and calculating risk levels from a start point to a destination defined by a user by utilizing a GPU parallel acceleration computation technique to calculate the optimal evacuation route.

The fourth step (S400) may be a step in which the operation control module generates, as output information including an image or video on a map, an optimal evacuation route result calculated through the evacuation route calculation modeling unit 3.

Here, the evacuation route calculation result image according to the fifth step (S500) may be sequentially displayed or stored and displayed as a video according to user definition.

In other words, in the evacuation route calculation system based on CBR contamination spread prediction according to an exemplary embodiment of the present disclosure, first, in order to calculate an evacuation route based on CBR contamination spread prediction in the event of a CBR contamination situation, the operation control module 4 inputs model input information including at least one of modeling target spatial information and environment setting information through the input information acquisition unit 1.

For example, in order to acquire system input information, the operation control module 4 inputs environment setting information such as an evacuation start point and destination desired for evacuation through the input unit 8 of the input information acquisition unit 1. At the same time, the operation control module 4 inputs model input information such as spatial information including modeling target roads and traffic volume through the spatial information acquisition unit 9 of the input information acquisition unit 1. The model input information input as described above may further comprise at least one selected from the group consisting of user input information and analysis control setting information.

Meanwhile, after the above process, the operation control module 4 receives data obtained by utilizing a contamination spread prediction tool within a designated area. That is, the operation control module 4 receives time-based contamination spread prediction data (including concentration and other data) calculated by a CBR contamination prediction tool, wherein the method of receiving contamination spread prediction data may include an offline method of reading pre-stored files from the memory unit 7 or an online method of receiving contamination spread prediction data through a real-time network connection.

After the above process, according to a function control signal of the operation control module 4, the evacuation route calculation modeling unit 3 calculates an optimal evacuation route based on the acquired spatial information such as roads, the evacuation start point and destination, and the contamination spread data.

That is, the evacuation route calculation modeling unit 3 calculates an optimal evacuation route from a start point to a destination within a designated area based on roads, traffic volume, and contamination spread prediction data by utilizing an evacuation route calculation modeling technique, and analyzes time-based contamination spread concentration, road, and traffic volume information calculated by the contamination spread prediction tool according to an exemplary embodiment of the present disclosure, and calculates risk levels from a start point to a destination defined by a user by utilizing a GPU parallel acceleration computation technique to calculate the optimal evacuation route.

Further, after the above process, the operation control module 4 generates evacuation route results created based on the contamination concentration calculated by the evacuation route calculation modeling unit 3 as output information including an image or video, and displays and outputs the generated output information through the output unit 5. The evacuation route result image may be sequentially displayed or stored and displayed as a video according to user definition.

Therefore, at a disaster site, for example, at a location where a CBR situation occurs, all persons present may promptly evacuate to a safe shelter by referring to the optimal evacuation route information calculated as described above.

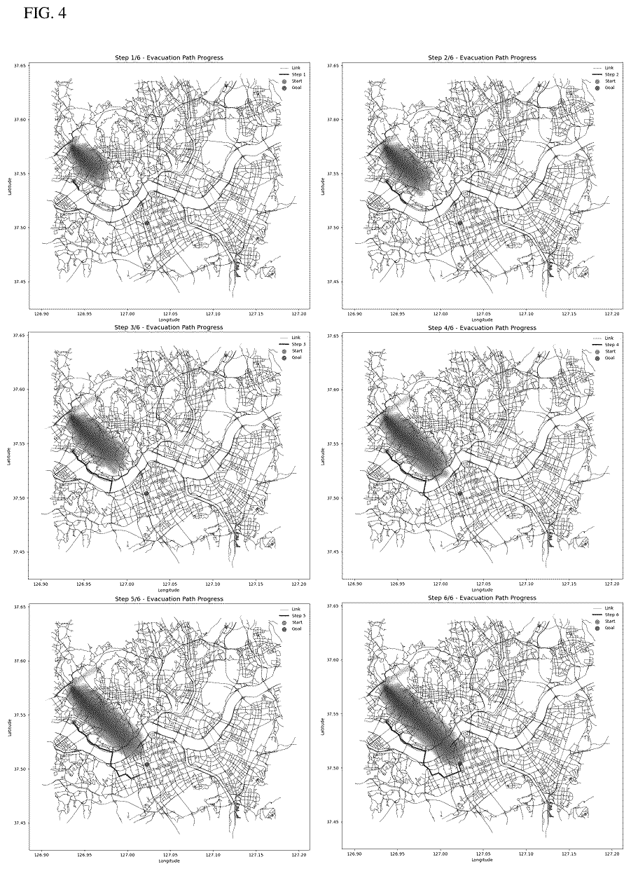

FIG. 4 is an explanatory diagram illustrating an example of results calculated by the control method of an evacuation route calculation system based on CBR contamination spread prediction according to an exemplary embodiment of the present disclosure.

As shown in FIG. 4, the operation control module 4 displays step by step the optimal evacuation route calculated from the spatial information acquired by the model input information acquisition unit 110 and the contamination prediction data acquired by the contamination spread prediction modeling data acquisition unit 2.

In addition, the operation control module 4 includes a function of reading various setting information acquired from the input information acquisition unit 110 according to the analysis type and storing the calculation results in the memory unit 7, and the calculated results are stored as an image or time-based video according to user settings and displayed on the screen through the output unit 5.

Furthermore, the displayed results may show, in an overlay format according to user settings, both the contamination prediction data used as input data and the result values of the optimal evacuation route.

The present disclosure, as described above, can be implemented as a computer-readable code on a medium on which a program is recorded. A computer-readable medium includes all kinds of recording devices in which data readable by a computer system are stored. Examples of computer-readable media include hard disk drives (HDD), solid state disks (SSD), silicon disk drives (SDD), read-only memory (ROM), random access memory (RAM), compact disc read-only memory (CD-ROM), magnetic tapes, floppy disks, optical data storage devices, and also include those implemented in the form of carrier waves (for example, transmission through the Internet). In addition, the computer may include the operation control module 4.

Meanwhile, it should be understood by those skilled in the art to which the present disclosure pertains that various modifications and variations can be made without departing from the essential characteristics of the present disclosure. Therefore, the detailed description above should not be interpreted in a restrictive sense but should be understood as illustrative.

The scope of the present disclosure should be determined by the reasonable interpretation of the appended claims, and all modifications within the equivalent scope thereof are included within the scope of the present disclosure.

As described above, according to the present disclosure, in the event of a CBR situation, an evacuation route can be automatically calculated from a starting point near the incident to a safe area based on time-based contamination spread prediction data obtained from a CBR contamination spread prediction tool within a user-defined area, thereby calculating a faster and more reliable CBR evacuation route and maximizing the evacuation safety of disaster victims.

Furthermore, according to the present disclosure, by applying time-based contamination spread data, roads, traffic volume, and other spatial information to an optimal route calculation algorithm when a CBR contamination occurs, an optimal evacuation route can be calculated and guided, thereby enabling disaster victims to be quickly evacuated to safe areas from CBR contamination and minimizing human casualties accordingly.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

1: input information acquisition unit
2: contamination spread prediction modeling data acquisition unit
3: evacuation route calculation modeling unit
4: operation control module
5: output unit
6: evacuation route calculation system based on CBR contamination spread prediction
7: memory unit
8: input unit
9: spatial information acquisition unit

1. An evacuation route calculation system based on CBR contamination spread prediction, comprising:
an input information acquisition unit configured to acquire user input information including at least one selected from the group consisting of modeling target spatial information, CBR contamination source information, and environment setting information;
a contamination spread prediction modeling data acquisition unit configured to calculate contamination spread prediction data in a space included in the user input information acquired by the input information acquisition unit by utilizing a contamination spread prediction tool;
an evacuation route calculation modeling unit configured to calculate an optimal evacuation route based on contamination information for each time period on roads and traffic volume, from the user input information acquired by the input information acquisition unit; and
an operation control module configured to comprehensively control the operation and functions of the input information acquisition unit, the contamination spread prediction modeling data acquisition unit, and the evacuation route calculation modeling unit, and to generate output information including an image or a video of the optimal evacuation route calculated based on a predicted contamination concentration,
wherein the evacuation route calculation modeling unit further comprises a function of generating an optimal evacuation route in time sequence, based on the user input information acquired by the input information acquisition unit according to a function control signal of the operation control module and the contamination spread prediction data between a start point and an end point,
wherein the contamination spread prediction data is received as input information calculated by the contamination spread prediction modeling data acquisition unit,
wherein a shortest path finding algorithm of the evacuation route calculation modeling unit comprises:
a process of calculating a cost by referring to road length, traffic volume, and expected contamination concentration during passage in a sequential movement process from a user-designated start point to a destination; and
a process of finding a route having a minimum cost by summing a cost calculated at a current point and an expected cost for reaching the destination, and
wherein the shortest path finding algorithm converts the contamination spread prediction data into information mapped on a map to calculate a contamination prediction concentration of a road for each time period.

2. The evacuation route calculation system of claim 1,
wherein the input information acquisition unit further comprises:
an input unit configured to input various conditions and environment setting information required for modeling to calculate an evacuation route; and
a spatial information acquisition unit configured to acquire modeling target spatial information for calculating the evacuation route.

3. The evacuation route calculation system of claim 2,
wherein the input unit is configured to input spatial information and environment setting information for calculating an optimal evacuation route in the event of a CBR incident, and to input environment setting information including various conditions and parameters for modeling, and
wherein the spatial information acquisition unit is configured to allow a user to select a target space to be predicted from a pre-stored space including road and traffic volume information of the target space.

4. The evacuation route calculation system of claim 1,
wherein model input information of the input information acquisition unit further comprises spatial information including roads and traffic volume according to a function control signal of the operation control module.

5. The evacuation route calculation system of claim 1,
wherein the contamination spread prediction modeling data acquisition unit further comprises a function of acquiring, online or offline, the contamination spread prediction data in the space for each time period; and
wherein the contamination spread prediction data is calculated by utilizing a contamination spread prediction modeling tool based on user input information acquired by the input information acquisition unit.

6. (canceled)

7. (canceled)

8. The evacuation route calculation system of claim 1,
wherein the operation control module further comprises a function of calculating an optimal evacuation route by utilizing a shortest path finding algorithm including the following Equations 1 and 2:
f(n)=g(n)+a·h(n) [Equation 1]
where f(n) represents a total cost (unit: seconds) calculated by summing an accumulated movement cost g(n) from a starting point to a current node (n step) and an expected risk cost h(n) expected on a remaining path between the current node (n step) and a destination;
g(n) represents an accumulated movement cost (unit: seconds) calculated by accumulating residence times of road links actually passed from the starting point to the current node (n step);
h(n) represents an expected risk cost (unit: seconds) calculated by accumulating products of residence time and contamination prediction concentration for each link on a remaining path from the current node (n step) to the destination; and
a denotes a risk reflection coefficient (range: 1.0-10.0) for adjusting the degree of reflection of the expected risk cost h(n);
$$h ( n ) = {{\sum }_{min}}_{path} ( residence time ( T ) \times contamination prediction concentration ( C ) ) \qquad [ Equation 2 ]$$
$$T = \frac{L ( i , j )}{v}$$
where h(n) represents an expected risk cost (unit: seconds) obtained by converting a risk exposure amount into a time cost by multiplying a contamination prediction concentration C and a residence time T for each road link (i, j) on a remaining path from the current node (n step) to the destination, and then summing time costs for all road links on the remaining path;
L(i, j) denotes a road link length (unit: meters);
v denotes a travel speed required to pass through the road link (i, j) (unit: m/sec);
T denotes a residence time required to pass through the road link (i, j) (unit: seconds); and
C denotes a contamination prediction concentration (unit: mg/m³) indicating an estimated degree of contamination exposure of a road at a given time during travel.

9. The evacuation route calculation system of claim 2,
wherein the spatial information acquisition unit is configured to store spatial information acquired by the spatial information acquisition unit in an internal memory unit through a preprocessing process for performing an evacuation route calculation modeling function.

10. The evacuation route calculation system of claim 2,
wherein the contamination spread prediction modeling data acquisition unit is configured to output data predicting a time-based contamination concentration (unit: mg/m³) on a ground surface; and
wherein the data is obtained as a result of a simulation performed for an area acquired by the spatial information acquisition unit by utilizing a contamination spread prediction modeling tool according to a function control signal of the operation control module.

11. The evacuation route calculation system of claim 2,
wherein the evacuation route calculation modeling unit further comprises a function of calculating an optimal evacuation route according to a function control signal of the operation control module, based on a start point, a destination, and CBR incident information acquired by a user through a user input unit, an area acquired by the spatial information acquisition unit, and contamination spread prediction information acquired by the contamination spread prediction modeling data acquisition unit.

12. A control method for an evacuation route calculation system based on CBR contamination spread prediction, comprising:
a first step of inputting, by an input information acquisition unit, according to a function control signal of an operation control module, model input information including at least one selected from the group consisting of modeling target spatial information and environment setting information;
a second step of receiving, after the first step, by the operation control module, data acquired by utilizing a contamination spread prediction tool within an area;
a third step of calculating, after the second step, by an evacuation route calculation modeling unit, according to a function control signal of the operation control module, an optimal evacuation route based on spatial information including roads, an evacuation start point and a destination, and contamination spread prediction data; and
a fourth step of generating, after the third step, by the operation control module, output information including an image or a video of an evacuation route result created based on a contamination concentration calculated by the evacuation route calculation modeling unit,
wherein a shortest path finding algorithm of the evacuation route calculation modeling unit comprises:
a process of calculating a cost by referring to road length, traffic volume, and expected contamination concentration during passage in a sequential movement process from a user-designated start point to a destination; and
a process of finding a route having a minimum cost by summing a cost calculated at a current point and an expected cost for reaching the destination, and
wherein the shortest path finding algorithm converts the contamination spread prediction data into information mapped on a map to calculate a contamination prediction concentration of a road for each time period.

13. The control method of claim 12,
wherein the first step further comprises:
an information input step of acquiring system input information according to a function control signal of the operation control module, wherein an input unit inputs environment setting information including an evacuation start point and a destination to which evacuation is intended; and
a spatial information input step of inputting, by a spatial information acquisition unit, spatial information including roads and traffic volume as modeling target information.

14. The control method of claim 12,
wherein the model input information of the first step further comprises at least one selected from the group consisting of user input information and analysis control setting information.

15. The control method of claim 12,
wherein the second step comprises receiving, according to a function control signal of the operation control module, contamination spread prediction data including time-based contamination concentration data calculated by a CBR contamination prediction tool, and
wherein the second step further comprises an offline method of reading pre-stored files and an online method of receiving contamination spread prediction data through a real-time network connection.

16. The control method of claim 12,
wherein the third step further comprises an optimal evacuation route calculation step of calculating, by utilizing an evacuation route calculation modeling technique, an optimal evacuation route from a start point to a destination within a designated area based on roads, traffic volume, and contamination spread prediction data; and
wherein the optimal evacuation route calculation step comprises analyzing time-based contamination spread concentration, road, and traffic volume information calculated by a contamination spread prediction tool, and calculating risk levels from the start point to the destination defined by a user by utilizing a GPU parallel acceleration computation technique to calculate the optimal evacuation route.
